(19) United States
(12) Patent Application Publication
(10) Pub. No.: US 2013/0104417 A1
(43) Pub. Date: May 2, 2013

(54) DRYING DEVICE FOR GLASS SUBSTRATE WITH ALIGNMENT LIQUID SPRAYED THEREON AND CONVEYING APPARATUS WITH THE SAME

(71) Applicant: Shaoxin Yu, Shenzhen (CN)

(72) Inventor: Shaoxin Yu, Shenzhen (CN)

(73) Assignee: Shenzhen China Star Optoelectronics Technology Co. , Ltd., Shenzhen, Guangdong (CN)

(21) Appl. No.: 13/380,065

(22) PCT Filed: Nov. 10, 2011
(86) PCT No.: PCT/CN2011/082039

§ 371 Date: Dec. 22, 2011

(30) Foreign Application Priority Data
Nov. 2, 2011 (CN) 201120428791.X

(51) Int. Cl. F26B 19/00

(52) U.S. Cl. 34/611

(57) ABSTRACT

The present disclosure provides a drying device for drying a glass substrate with alignment liquid sprayed thereon. The drying device includes a container, a belt conveying mechanism, and an infra-red heater. The belt conveying mechanism is disposed inside the container for conveying the glass substrate. The belt conveying mechanism includes a conveyer for supporting the glass substrate. The infra-red heater is disposed on an inner surface of the container and corresponding to an external surface of the conveyer contacting the glass substrate. The present disclosure further provides a conveying apparatus with the drying device. With the drying device and the conveying apparatus of the present disclosure, the glass substrate is conveyed by the conveyer and is heated evenly. Thus, a situation where the glass substrate is unevenly heated and a thickness of the alignment film become non-uniform can be avoided somewhat.

### BACKGROUND

1. Technical Field

The present disclosure relates to a drying device for drying a glass substrate with alignment liquid sprayed thereon and a conveying apparatus with the same.

2. Description of Related Art

In the manufacturing process of a liquid crystal display (LCD), an alignment film is used for allowing all liquid crystal molecules to be arranged in a predetermined position. Alignment liquid is sprayed on a glass substrate via an ink jet head and a spraying nozzle, and is heated to allow almost 80% of the organic solvent thereof to be evaporated. Thus, the glueyness of the alignment liquid becomes higher to form the alignment film of a predetermined thickness.

In the manufacturing process of a conventional liquid crystal display, the alignment liquid is heated and dried by an infra-red (IR) heating plate. The glass substrate is heated by the IR heating plate to reach 90 degrees centigrade to evaporate various kinds of organic solvent of the alignment liquid. However, since a thimble used for supporting the glass substrate is not made of pure heat insulating material, thus, a certain amount of heat may be conducted to the glass substrate via the thimble. In this state, the glass may be unevenly heated and the thickness of the alignment film may become non-uniform.

Therefore, two methods are often applied for solving the above problem:

In a first method, the glass substrate is supported by two sets of movable thimbles. The two sets of movable thimbles support the glass substrate in turn to avoid a situation where one thimble contacts the glass substrate at the same point for a long time.

In a second method, the glass substrate is supported by two set of independent thimbles. One set of the thimbles are fixed to the glass substrate for supporting the glass substrate, and the other set of the thimbles are capable of moving the glass substrate to change the contacting point between the glass substrate and the other set of the thimbles.

In the above two methods, thimbles are still needed to support the glass substrate when heating the alignment liquid. Therefore, the situation where a certain amount of heat is conducted to the glass substrate by the thimbles and the glass substrate cannot be evenly heated still cannot be avoided.

### SUMMARY

The present disclosure provides a drying device for drying a glass substrate with alignment liquid sprayed thereon. The drying device includes a container, a belt conveying mechanism, and an infra-red heater. The belt conveying mechanism is disposed inside the container for conveying the glass substrate. The belt conveying mechanism includes a conveyer for supporting the glass substrate. The conveyer is made of Teflon, and a length of the conveyer along a direction perpendicular to a moving direction of the conveyer is equal to or larger than that of the glass substrate. The infra-red heater is disposed on an inner surface of the container and corresponding to an external surface of the conveyer contacting the glass substrate.

Preferably, the container defines a first through hole and a second through hole corresponding to the first through hole, the glass substrate is capable of entering into the container through the first through hole and moving out of the container through the second through hole, the container further includes two stoppers respectively corresponding to the first through hole and the second through hole for sealing the container.

Preferably, the belt conveying mechanism further includes a driving wheel and a driven wheel for supporting the conveyer, the conveyer forms a circle surrounding the driving wheel and the driven wheel.

Preferably, the belt conveying mechanism further includes a driving assembly, the driving assembly includes at least one driving belt and a motor, the conveyer is driven to move when the motor drives the driving belt.

Preferably, the driving assembly further includes a first shaft centralized by the driving wheel for driving the driving wheel and a second shaft centralized by the driven wheel for driving the driven wheel, the motor includes a third shaft, the first shaft includes a first end corresponding to the motor and a second end opposite to the first end, the second shaft includes a third end corresponding to the second end, the driving assembly includes two of the driving belts, one of the driving belts forms a circle and surrounds the third shaft and the first end, and the other one of the driving belt forms a circle and surrounds the second end and the third end.

The present disclosure further provides another drying device for drying a glass substrate with alignment liquid sprayed thereon. The drying device includes a container, a belt conveying mechanism disposed inside the container, including a conveyer for supporting the glass substrate, and a heater disposed on inner surface of the container and corresponding to an external surface of the conveyer contacting the glass substrate.

Preferably, the conveyer is made of Teflon and a length thereof along a direction perpendicular to a moving direction of the conveyer is equal to or larger than that of the glass substrate.

Preferably, the heater is an infra-red heater.

Preferably, the container defines a first through hole and a second through hole corresponding to the first through hole, the glass substrate is capable of entering into the container through the first through hole and moving out of the container through the second through hole, the container further includes two stoppers respectively corresponding to the first through hole and the second through hole for sealing the container.

Preferably, the belt conveying mechanism further includes a driving wheel and a driven wheel for supporting the conveyer, the conveyer forms a circle surrounding the driving wheel and the driven wheel.

Preferably, belt conveying mechanism further includes a driving assembly, the driving assembly includes at least one driving belt and a motor, the conveyer is driven to move when the motor drives the driving belt.

Preferably, the driving assembly further includes a first shaft centralized by the driving wheel for driving the driving wheel and a second shaft centralized by the driven wheel for driving the driven wheel, the motor includes a third shaft, the first shaft includes a first end corresponding to the motor and a second end opposite to the first end, the second shaft includes a third end corresponding to the second end, the driving assembly includes two of the driving belts, one of the driving belts forms a circle and surrounds the third shaft and the first end, and the other one of the driving belt forms a circle and surrounds the second end and the third end.

The present disclosure further yet provides a conveying apparatus for conveying a glass substrate. The conveying apparatus includes a drying device, a first transferring device, and a second transferring device. The drying device includes a container, a belt conveying mechanism, and an infra-red heater. The belt conveying mechanism is disposed inside the container and is used for conveying the glass substrate, and includes a conveyer for contacting and supporting the glass substrate. The conveyer is made of Teflon, and a length of the conveyer along a direction perpendicular to a moving direction of the conveyer is equal to or larger than that of the glass substrate. The infra-red heater is disposed on an inner surface of the container and corresponds to an external surface of the conveyer contacting the glass substrate. The first transferring device corresponds to a first side of the drying device for transferring the glass substrate into the container. The second transferring device corresponds to a second side of the drying device opposite to the first side for transferring the glass substrate out of the container.

Preferably, the conveyer is made of Teflon and a length thereof along a direction perpendicular to a moving direction of the conveyer is equal to or larger than that of the glass substrate.

Preferably, the heater is an infra-red heater.

Preferably, the container forms a first through hole and a second through hole corresponding to the first through hole, the glass substrate is capable of entering into the container through the first through hole and moving out of the container through the second through hole, the container further includes two stoppers respectively corresponding to the first through hole and the second through hole for sealing the container.

Preferably, the belt conveying mechanism further includes a driving wheel and a driven wheel for supporting the conveyer, the conveyer forms a circle surrounding the driving wheel and the driven wheel.

Preferably, belt conveying mechanism further includes a driving assembly, the driving assembly includes at least one driving belt and a motor, the conveyer is driven to move when the motor drives the at least one driving belt.

Preferably, the driving assembly further includes a first shaft centralized by the driving wheel for driving the driving wheel and a second shaft centralized by the driven wheel for driving the driven wheel, the motor includes a third shaft, the first shaft includes a first end corresponding to the motor and a second end opposite to the first end, the second shaft includes a third end corresponding to the second end, the driving assembly includes two of the driving belts, one of the driving belts forms a circle and surrounds the third shaft and the first end, and the other one of the driving belt forms a circle and surrounds the second end and the third end.

In the present disclosure, the belt conveying mechanism is disposed inside the container, and the heater is disposed on the inner surface of the container to correspond to the external surface of the conveyer directly. Therefore, the heater can heat the glass substrate after the glass substrate enters into the container. Additionally, the glass substrate can be placed above the conveyer without the support of thimbles, that is, the glass substrate can contact the conveyer completely to allow the glass substrate to be heated evenly. Thus, stripes may not be generated on the surface of the glass substrate due to the omission of the thimbles.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a drying device in accordance with an embodiment of the present disclosure, and the drying device includes a belt conveying mechanism.

FIG. 2 is a schematic view showing heat absorption and heat loss of the glass substrate on the belt conveying mechanism of FIG. 1.

FIG. 3 is a top view of the belt conveying mechanism of FIG. 1.

FIG. 4 is a schematic view of a conveying apparatus for conveying a glass substrate in accordance with a first embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

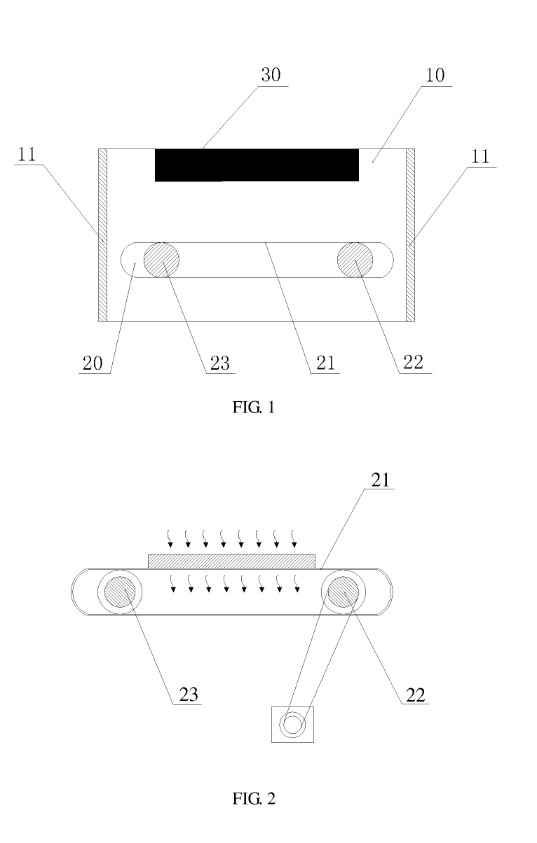

Referring to FIG. 1, a drying device for heating and drying a glass substrate with alignment liquid sprayed thereon includes a container 10, a belt conveying mechanism 20 for conveying the glass substrate, a heater 30 for heating the glass substrate. Both the belt conveying mechanism 20 and the heater 30 are disposed inside the container 10.

The container 10 includes a first through hole and a second through hole respectively defined in two opposite sides of the container 10. The glass substrate is capable of entering into the container 10 through the first through hole and move out of the container 10 through the second through hole after being dried. The container 10 further includes two stoppers 11 respectively corresponding to the first through hole and the second through hole. The two stoppers 11 are capable of respectively blocking the first and second through holes to seal the container 10 and thus increase the air tightness of the container 10. When the glass substrate enters into the container 10, one of the two stoppers 11 corresponding to the first through hole is opened to allow the glass substrate to enter into the container 10. After the glass substrate is located in the container 10 completely, the stopper 11 corresponding to the first through hole is closed to block the first through hole. After the glass substrate is dried, the other one of the two stoppers 11 corresponding to the second through hole is opened to allow the glass substrate to move out of the container 10.

The belt conveying mechanism 20 includes a conveyer 21, a driving wheel 22 and a driven wheel 23 parallel to the driving wheel 22. The conveyer 21 forms a circle, and the driving wheel 22 and the driven wheel 23 are respectively located at two opposite sides inside the circle. The driving wheel 22 and the driven wheel 23 are used for supporting the conveyer 21 such that the conveyer 21 can support the glass substrate when the glass substrate enters into the container 10. In the embodiment, the conveyer 21 is made of Teflon, which allows the conveyer 21 to have a high heat resistance and a strong thermal stability and not to be fused easily under high temperature. In this state, the glass substrate can be placed above the conveyer 21 and can contact the conveyer 21 completely. Also, no thimbles are needed to support the glass substrate. Thus, the glass substrate can be heated evenly and a thickness of the alignment film may become uniform. Also, no strips are generated on the glass substrate due to the thimbles used for supporting glass substrate.

The heater 30 is disposed on an inner surface of the container 10 and corresponds to an external surface of the conveyer 21. The heater 30 is used for heating the alignment liquid sprayed on the glass substrate when the glass substrate is conveyed to the container 10 by the conveyer 21. In the embodiment, the heater 30 is an infra-red heater and a length of the heater 30 is equal to or larger than that of the glass substrate along a direction perpendicular to a moving direction of the conveyer 21.

Referring to FIG. 2, after the glass substrate is placed on the conveyer 21, the glass substrate contacts the external surface of the conveyer 21 completely. Since the heater 30 corresponds to the external surface of the conveyer 21, thus, the heat can be conducted to the glass substrate evenly.

After the glass substrate is heated by the heater 30, the conveyer 21 can dissipate the heat absorbed by the glass substrate. Since the glass substrate contacts the external surface of the conveyer 21 completely, the conveyer 21 can dissipate the heat evenly. Thus, a heat absorption rate and a heat loss rate of each point of the glass substrate remain unchanged to allow the alignment liquid film to be coated on the glass substrate uniformly.

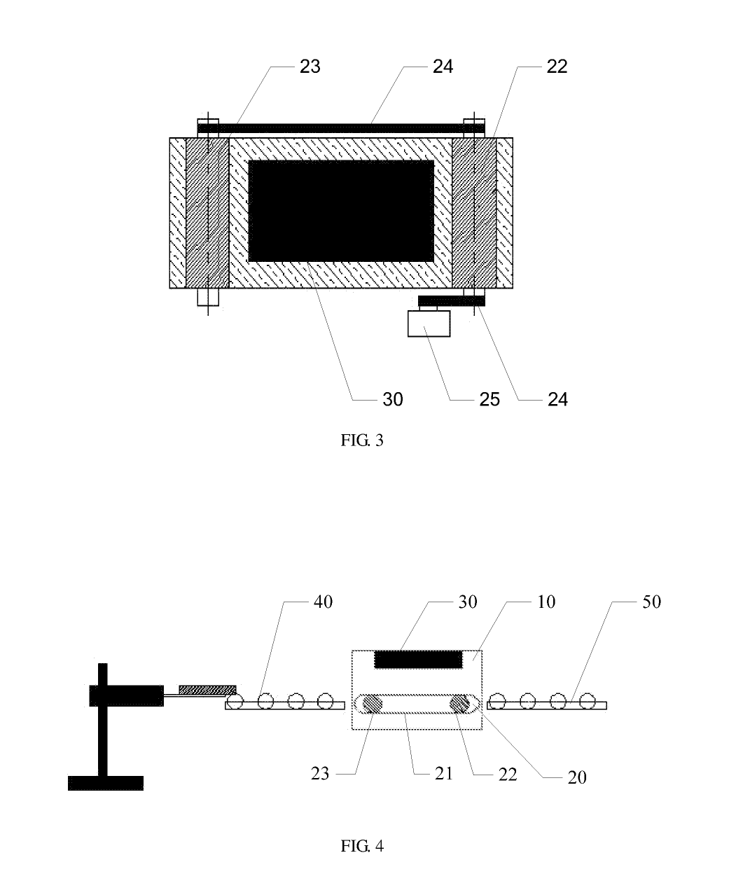

Referring to FIG. 3, the belt conveying mechanism 20 further includes a driving assembly for driving the driving wheel 22 and the driven wheel 23 to rotate. Thus, the conveyer 21 can be driven to move to convey the glass substrate. The driving assembly includes a first shaft, a second shaft, two driving belts 24, and a motor 25. The first shaft is centralized by the driving wheel 22 for driving the driving wheel 22 to rotate. The first shaft includes a first end corresponding to the motor 25 and a second end opposite to the first end. The second shaft is centralized by the driven wheel 23 for driving the driven wheel 23 to rotate. The second shaft includes a third end substantially aligning with the second end of the first shaft. One of the driving belts 24 forms a circle and surrounds the first end of the first shaft and a third shaft of the motor 25. The other one of the driving belts 24 also forms a circle and surrounds the second end of the first shaft and the third end of the second shaft.

In operation, when the motor 25 begins to work, one of the driving belts 24 is driven to move to drive the driving wheel 22 to rotate. After the driving wheel 25 begins to rotate, the other one of the driving belts 24 is driven to move to drive the driven wheel 23 to rotate. In this state, the conveyer 21 can work to convey the glass substrate. With the driving assembly, the conveyer 21 can be driven to move under the driving of the driving wheel 22 and the driven wheel 23. Therefore, the glass substrate is allowed to move at even speed after entering into the container 10 and absorbing the heat from the heater 30, which further ensures a uniform thickness of the alignment film.

Referring to FIG. 4, the present disclosure further provides a conveying apparatus for conveying a glass substrate with alignment liquid sprayed thereon. The conveying apparatus 100 includes a drying device for heating and drying the glass substrate, a first transferring device 40 transferring the glass substrate into the drying device, and a second transferring device 50 for transferring the glass substrate out of the drying device.

The drying device includes a container 10, a belt conveying mechanism 20 for conveying the glass substrate, a heater 30 for heating the glass substrate. Both the belt conveying mechanism 20 and the heater 30 are disposed inside the container 10.

The container 10 includes a first through hole and a second through hole respectively defined in two opposite sides of the container 10. The glass substrate is capable of entering into the container 10 through the first through hole and move out of the container 10 through the second through hole after being dried. The container 10 further includes two stoppers 11 respectively corresponding to the first through hole and the second through hole. The two stoppers 11 are capable of respectively blocking the first and second through holes to seal the container 10 and thus increase the air tightness of the container 10. When the glass substrate enters into the container 10, one of the two stoppers 11 corresponding to the first through hole is opened to allow the glass substrate to enter into the container 10. After the glass substrate is located in the container 10 completely, the stopper 11 corresponding to the first through hole is closed to block the first through hole. After the glass substrate is dried, the other one of the two stoppers 11 corresponding to the second through hole is opened to allow the glass substrate to move out of the container 10.

The belt conveying mechanism 20 includes a conveyer 21, a driving wheel 22 and a driven wheel 23 parallel to the driving wheel 22. The conveyer 21 forms a circle and the driving wheel 22 and the driven wheel 23 are respectively located at two opposite sides inside the circle. The driving wheel 22 and the driven wheel 23 are used for supporting the conveyer 21 such that the conveyer 21 can support the glass substrate when the glass substrate enters into the container 10. In the embodiment, the conveyer 21 is made of Teflon, which allows the conveyer 21 to have a high heat resistance and a strong thermal stability and not to be fused easily under high temperature. In this state, the glass substrate can be placed above the conveyer 21 and can contact the conveyer 21 completely. Also, no thimbles are needed to support the glass substrate. Thus, the glass substrate can be heated evenly and a thickness of the alignment film may become uniform. Also, no strips are generated on the glass substrate due to the thimbles used for supporting glass substrate.

The heater 30 is disposed on an inner surface of the container 10 and corresponds to an external surface of the conveyer 21. The heater 30 is used for heating the alignment liquid sprayed on the glass substrate when the glass substrate is conveyed to the container 10 by the conveyer 21. In the embodiment, the heater 30 is an infra-red heater and a length of the heater 30 is larger than that of the glass substrate along a direction perpendicular to a moving direction of the conveyer 21.

The first transferring device 40 corresponds to a first side of the container 10 for transferring the glass substrate into the container 10. The second transferring device 50 corresponds to a second side of the container 10 opposite to the first side thereof for transferring the glass substrate out of the container 10. In some embodiments, a first manipulator may be disposed in front of the first transferring device 40 for carrying and placing a to-be-dried glass substrate onto the first transferring device 40, and a second manipulator may be disposed behind the second transferring device 50 for picking the dried glass substrate away from the second transferring device 50.

In the present disclosure, the belt conveying mechanism 20 is disposed inside the container 10, and the heater 30 is disposed on the inner surface of the container 10 to correspond to the external surface of the conveyer 21 directly. Therefore, the heater 30 can heat the glass substrate after the glass substrate enters into the container 10. Also, with the two stoppers 11, the container 10 can be sealed to be airtight so as to allow the glass substrate to be dried easily and quickly. Additionally, the glass substrate can be placed above the conveyer 21 without the support of thimbles, that is, the glass substrate can contact the conveyer 21 completely to allow the glass substrate to be heated evenly. Thus, stripes may not be generated on the surface of the glass substrate due to the omission of the thimbles.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A drying device for drying a glass substrate with alignment liquid sprayed thereon, comprising:
a container;
a belt conveying mechanism disposed inside the container for conveying the glass substrate, the belt conveying mechanism comprising a conveyer for supporting the glass substrate, the conveyer being made of Teflon, and a length of the conveyer along a direction perpendicular to a moving direction of the conveyer being equal to or larger than that of the glass substrate; and
an infra-red heater disposed on an inner surface of the container and corresponding to an external surface of the conveyer contacting the glass substrate.

2. The drying device as claimed in claim 1, wherein the container defines a first through hole and a second through hole corresponding to the first through hole, the glass substrate is capable of entering into the container through the first through hole and moving out of the container through the second through hole, the container further comprises two stoppers respectively corresponding to the first through hole and the second through hole for sealing the container.

3. The drying device as claimed in claim 1, wherein the belt conveying mechanism further comprises a driving wheel and a driven wheel for supporting the conveyer, the conveyer forms a circle surrounding the driving wheel and the driven wheel.

4. The drying device as claimed in claim 3, wherein the belt conveying mechanism further comprises a driving assembly, the driving assembly comprises at least one driving belt and a motor, the conveyer is driven to move when the motor drives the at least one driving belt.

5. The drying device as claimed in claim 4, wherein the driving assembly further comprises a first shaft centralized by the driving wheel for driving the driving wheel and a second shaft centralized by the driven wheel for driving the driven wheel, the motor comprises a third shaft, the first shaft comprises a first end corresponding to the motor and a second end opposite to the first end, the second shaft comprises a third end corresponding to the second end, the driving assembly comprises two of the driving belts, one of the driving belts forms a circle and surrounds the third shaft and the first end, and the other one of the driving belt forms a circle and surrounds the second end and the third end.

6. A drying device for drying a glass substrate with alignment liquid sprayed thereon, comprising:
a container;
a belt conveying mechanism disposed inside the container, the belt conveying mechanism comprising a conveyer for supporting the glass substrate;
a heater disposed on an inner surface of the container and corresponding to an external surface of the conveyer contacting the glass substrate.

7. The drying device as claimed in claim 6, wherein the conveyer is made of Teflon and a length thereof along a direction perpendicular to a moving direction of the conveyer is equal or larger than that of the glass substrate.

8. The drying device as claimed in claim 6, wherein the heater is an infra-red heater.

9. The drying device as claimed in claim 8, wherein the container defines a first through hole and a second through hole corresponding to the first through hole, the glass substrate is capable of entering into the container through the first through hole and moving out of the container through the second through hole, the container further comprises two stoppers respectively corresponding to the first through hole and the second through hole for sealing the container.

10. The drying device as claimed in claim 6, wherein the belt conveying mechanism further comprises a driving wheel and a driven wheel for supporting the conveyer, the conveyer forms a circle surrounding the driving wheel and the driven wheel.

11. The drying device as claimed in claim 10, wherein the belt conveying mechanism further comprises a driving assembly, the driving assembly comprises at least one driving belt and a motor, the conveyer is driven to move when the motor drives the at least one driving belt.

12. The drying device as claimed in claim 11, wherein the driving assembly further comprises a first shaft centralized by the driving wheel for driving the driving wheel and a second shaft centralized by the driven wheel for driving the driven wheel, the motor comprises a third shaft, the first shaft comprises a first end corresponding to the motor and a second end opposite to the first end, the second shaft comprises a third end corresponding to the second end, the driving assembly comprises two of the driving belts, one of the driving belts forms a circle and surrounds the third shaft and the first end, and the other one of the driving belt forms a circle and surrounds the second end and the third end.

13. A conveying apparatus for conveying a glass substrate with alignment liquid sprayed thereon, comprising:
a drying device, comprising:
a container;
a belt conveying mechanism disposed inside the container for conveying the glass substrate, comprising a conveyer for supporting the glass substrate, the conveyer being made of Teflon, and a length of the conveyer along a direction perpendicular to a moving direction of the conveyer being equal to or larger than that of the glass substrate; and
an infra-red heater disposed on an inner surface of the container and corresponding to an external surface of the conveyer contacting the glass substrate;
a first transferring device corresponding to a first side of the drying device for transferring the glass substrate into the container; and
a second transferring device corresponding to a second side of the drying device opposite to the first side for transferring the glass substrate out of the container.

14. The conveying apparatus as claimed in claim 13, wherein the conveyer is made of Teflon and a length thereof along a direction perpendicular to a moving direction of the conveyer is equal to or larger than that of the glass substrate.

15. The conveying apparatus as claimed in claim 14, wherein the heater is an infra-red heater.

16. The conveying apparatus as claimed in claim 15, wherein the container defines a first through hole and a second through hole corresponding to the first through hole, the glass substrate is capable of entering into the container through the first through hole and moving out of the container through the second through hole, the container further comprises two stoppers respectively corresponding to the first through hole and the second through hole for sealing the container.

17. The conveying apparatus as claimed in claim 13, wherein the belt conveying mechanism further comprises a driving wheel and a driven wheel for supporting the conveyer, the conveyer forms a circle surrounding the driving wheel and the driven wheel.

18. The conveying apparatus as claimed in claim 17, wherein the belt conveying mechanism further comprises a driving assembly, the driving assembly comprises at least one driving belt and a motor, the conveyer is driven to move when the motor drives the at least one driving belt.

19. The conveying apparatus as claimed in claim 18, wherein the driving assembly further comprises a first shaft centralized by the driving wheel for driving the driving wheel and a second shaft centralized by the driven wheel for driving the driven wheel, the motor comprises a third shaft, the first shaft comprises a first end corresponding to the motor and a second end opposite to the first end, the second shaft comprises a third end corresponding to the second end, the driving assembly comprises two of the driving belts, one of the driving belts forms a circle and surrounds the third shaft and the first end, and the other one of the driving belt forms a circle and surrounds the second end and the third end.
